(19) United States
(12) Patent Application Publication
(10) Pub. No.: US 2026/0235731 A1
(43) Pub. Date: Aug. 13, 2026

(54) OPTICAL ILLUMINATION SYSTEM FOR DISTANCE MEASUREMENT CROSS-REFERENCE TO RELATED APPLICATIONS

(71) Applicant: SAMSUNG ELECTRONICS CO., LTD., Suwon-si (KR)

(72) Inventors: Elena Gennadievna MALINOVSKAYA, Moscow (RU); Margarita Ilgizovna SHARIPOVA, Ufa City (RU); Viktoriia Sergeevna KAIDARAKOVA, Odintsovo (RU); Stepan Evgenievich IVANOV, Saint Petersburg (RU); Dmitrii Evgenyevich PISKUNOV, Pushkin District (RU); Stanislav Aleksandrovich SHTYKOV, Moscow (RU); Byungkwon KANG, Suwon-si (KR); Dongil SEO, Suwon-si (KR); Kwanyong LEE, Suwon-si (KR); Jeongyeol LEE, Suwon-si (KR)

(73) Assignee: SAMSUNG ELECTRONICS CO., LTD., Suwon-si (KR)

(21) Appl. No.: 19/434,983

(22) Filed: Dec. 29, 2025

Related U.S. Application Data
(63) Continuation of application No. PCT/KR2025/013990, filed on Sep. 9, 2025.

(30) Foreign Application Priority Data
Feb. 7, 2025 (RU) 2025102697

(51) Int. Cl. G01S 7/481; G01S 7/4865; G02F 1/13363; G02F 1/29

(52) U.S. Cl. CPC G01S 7/4814; G01S 7/4865; G02F 1/13363; G02F 1/294

(57) ABSTRACT

An optical illumination system for a time-of-flight (ToF) imaging device includes: at least one unpolarized light source module configured to emit light; at least two spatially-separated liquid crystal (LC) gratings configured to spatially separate the light into a plurality of spatially-separated light components having orthogonal circular polarizations, and to redirect the plurality of spatially-separated light components to at least one active retarder; the at least one active retarder placed after the at least two spatially separated LC gratings along an illumination path, wherein the at least one active retarder may be further configured to change a polarization state of the light to an opposite polarization state, and to switch between a spot illumination mode and a flood illumination mode, wherein according to the spot illumination mode, a point illumination pattern including a plurality of point illumination spots is generated on a surface of an illuminated object, and according to the flood illumination mode, a continuous illuminated spot is generated on the surface of the illuminated object; at least one LC lens placed after the at least one active retarder along the illumination path, wherein the at least one LC lens may be further configured to generate an illumination field, wherein the plurality of spatially-separated light components include a first light component having a first circular polarization, and a second light component having a second circular polarization that is orthogonal to the first circular polarization, wherein the at least one LC lens has a positive optical power with respect the first light component according to the spot illumination mode, and wherein the at least one LC lens has a negative optical power with respect the second light component according to the flood illumination mode.

### CROSS-REFERENCE TO RELATED APPLICATIONS

This application is a continuation of International Application No. PCT/KR2025/013990, filed on Sep. 9, 2025, in the Korean Intellectual Property Receiving Office, which is based on and claims priority to Russian Patent Application No. 2025102697 filed on Feb. 7, 2025, in the Russian Federal Service for Intellectual Property, the disclosures of which are incorporated by reference herein in their entireties.

### BACKGROUND

### 1. Field

The disclosure relates to a process for determining distance to an object using Time-of-Flight (ToF) imaging, and, more specifically, to illumination systems used for this.

### 2. Description of Related Art

Time-of-Flight (ToF) imaging may be used in a process for determining a distance to an object. Such a process may be useful in many technological fields, for example fields relating to computer vision, robotic vision systems, industrial automation, security devices, autonomous vehicles, autonomous movement of household appliances and unmanned vehicles, extended reality (XR) devices, virtual reality (VR) devices, augmented reality (AR) devices, mixed reality (MR) devices, in mobile devices, in gaming systems and in many other areas of modern technology.

ToF imaging may be used to measure distance by calculating the time required for light to travel a certain distance in a medium. A ToF measurement process may include using a light source to emit a light pulse, which may for example have a wavelength in an infrared (IR) range, and recording the emission time. The light pulse may then be reflected from the object (or from a part of the object, such as a human face, or a set of objects, such as cars and poles on a road) and captured by a receiver, and a reception time of the reflected light pulse may be recorded. A difference between the emission time and the reception time of the light pulse may be used to determine distance to the object. Thus, a ToF ranging system may include a synchronized illumination subsystem and a detection subsystem.

In some approaches, the ToF illumination subsystem may have an angular field of illumination, which may determine the range of angles in which a radiation propagates, and, accordingly, from which the receiver collects the signal and then generates an image. Within the angular field of illumination, the intensity distribution may be either continuous or not, forming a pattern of illumination distribution, for example, a two-dimensional periodic array of dots.

To ensure that the ToF ranging system operates over a wide range of distances (e.g., both short and long distances), some illumination subsystems operate according to two modes, for example a flood illumination mode (e.g., a flood mode) or continuous mode to obtain high resolution images at a short distance, and a spot illumination mode (e.g., spot mode) for obtaining information from a large distance, but with reduced resolution, wherein an improved signal-to-noise ratio may be achieved by focusing the optical power only at individual points in the angular field of illumination, rather than uniformly over the entire area.

Some ToF illumination subsystems may include a short range illumination system operating in a single illumination mode (e.g., a flood or spot mode) using one channel with one light source module, without switching elements; Some ToF illumination subsystems may include an illumination system having a wide range of distance measurement, having two illumination modes (flood mode and spot mode), which determines the presence of two spatially separated channels containing a light source module in each channel, for each illumination mode.

Some ToF illumination subsystems may include an illumination system with a wide range of distance measurements, having two illumination modes (flood and spot modes), using one channel with one light source module and with mechanical switching between modes due to mechanical movement of the illumination system elements.

Some light sources used for the illumination system may include a vertical cavity surface emitting laser (VCSEL), which may refer to an array of light sources that emit unpolarized light having a wavelength in the IR range (e.g., about 940 nm).

However, the ToF illumination subsystems described above may have problems that prevent the achievement of a large range of distance measurement for distance sensing devices.

For example, the ToF illumination subsystems described above may include non-compact and expensive illumination systems for a ToF camera module. In addition, to determine distance to an object over a wide range of distances, the ToF illumination subsystems described above may use two illumination modes, (e.g. the flood illumination mode and the spot illumination mode), which must be switched between. Therefore, the ToF illumination subsystems described above may use two separate channels with two light source modules (e.g., a flood illumination mode module with an IR pulsed light source (e.g., an IR pulsed VCSEL), and a spot illumination mode module with an IR pulsed light source (e.g., an IR pulsed VCSEL), or a single channel with one light source module with mechanical switching between flood illumination mode and spot illumination mode according to mechanical movement of the illumination system elements.

In addition, the ToF illumination subsystems described above may use an unpolarized light source (e.g., an unpolarized VCSEL). When the ToF illumination subsystems use polarization-sensitive optical elements to form a radiation distribution based on a unpolarized light source, the illumination brightness may decrease, which may lead to a decrease in the range of distance measurement.

To solve these problems and to create technical solutions that have the above-mentioned characteristics, various approaches have been used.

For example, as disclosed in U.S. Pat. No. 11,882,263 B2, issued on Jan. 23, 2024, a time-of-flight (ToF) imaging camera includes a light source unit, including an array of infrared light-emitting devices and configured to generate a light signal; a lens unit, placed on the light source unit and including a plurality of lenses; and an adjustment unit, configured to adjust the lens unit so that the light pattern of the light signal passed through the lens unit becomes continuous illumination or point illumination.

However, this solution has the following disadvantages: low brightness and small range of distance measurement for an unpolarized light source; low operational reliability; and switching using an active liquid lens or an active gradient refractive index (GRIN) lens, or an active acoustic lens, which leads to an increase in the cost of the lighting module.

In addition, as disclosed in US Patent Application Publication No. 2023/0358891 A1, published on Nov. 9, 2023a system time-of-flight imaging, includes: a light source for illuminating an object for which the time of flight shall be measured; an optical system configured to use at least one actuator to switch the light source between a spot illumination mode (spot mode) and a flood illumination mode (flood mode); and a sensor including a sensor surface with a photosensitive matrix. The sensor surface is configured to perceive radiation scattered by the object from the light source and to provide data depending on the perceived radiation. The point illumination has a spatially non-uniform intensity distribution over the sensor surface, and the optical system is configured to move the point illumination over at least a portion of the sensor surface to generate an output frame, wherein at least one actuator comprises at least one shape memory alloy (SMA) component.

However, this solution has some disadvantages, such as the presence of mechanical switching between flood illumination mode and spot illumination mode and the presence of a complex and bulky design.

In addition, as disclosed in Chinese Patent No. CN 113238248 A, published on Aug. 10, 2021, a 3D visualization device combining structured illumination and ToF technology includes: a projection module comprising a light source, a collimator lens and a diffractive optical element; wherein the projection module has a structured radiation illumination mode and a ToF illumination mode; a mode of projecting a structured illumination pattern onto a target object in the structured illumination mode; a mode of projecting a floodlight pattern onto a target object in the ToF illumination mode; a receiving module for collecting an optical signal emitted by the target object; and a control and computing module used to control the projection module and the receiving module and to calculate depth information of the target object in accordance with the optical signals collected by the receiving module. This device integrates two working modes of structured illumination and ToF technology, and when using it, there may be no need to add other component structures, the number of integrated components is reduced, the module size is reduced, the integration level is effectively increased, and the range of application of the device is greatly expanded.

However, this solution has its own shortcomings, which include the presence of mechanical switching between flood illumination mode and spot illumination mode, a limited service life, and a complex and bulky design.

In addition, as disclosed in US Patent Application Publication No. 2022/0353442 A1, published Nov. 3, 2022, a device for a time-of-flight (ToF) imaging camera, includes an optical transmitter configured to transmit radiation to an object, an optical receiver configured to receive radiation reflected from the object, and a drive configured to adjust either one or both directions of optical scanning and the field of illumination of the optical transmitter. This device is characterized by the fact that the block of liquid crystal switchable lenses of the optical transmitter can change the angle of the field of illumination in response to the supply of voltage, and also by the fact that the angle of the field of illumination is adjusted using a lens on a diffractive optical element (DOE). The angle of the field of illumination can be adjusted to a narrow or wide value by moving the position of the first DOE lens along the optical axis.

However, this solution has some drawbacks, such as the lack of a flood illumination mode and the presence of a polarization-sensitive active liquid crystal lens, which results in reduced brightness and a small range of distance measurements for an unpolarized light source.

In addition, as disclosed in US Patent Application Publication No. 2023/0019896 A1, published on Jan. 19, 2023, an illumination device for a ToF camera for improving distance measurements is configured to illuminate a certain area on the illumination plane with two different illumination modes, such as a first continuous illumination mode and a second illumination mode with a dot pattern. The continuous illumination mode can provide a measurement with improved lateral resolution, while the dot pattern illumination can provide a measurement with improved depth resolution, so that at the same time, part of the array of emitting elements operates in one mode, and part in another.

However, this solution has some drawbacks, such as the lack of switching between illumination modes, which results in reduced brightness, a small range of distance measurements, and reduced resolution in spot illumination mode.

In addition, as disclosed in U.S. Pat. No. 9,335,586 B2, issued on May 10, 2016, a polarization conversion system includes a lens element, a polarization grating containing a diffraction element with a spatially changing local optical axis, and a retarder. The polarization grating is intended to receive radiation that is output from the lens element, and the retarder is intended to receive polarized light with different polarization states that is output from the polarization grating, and to change different polarization states to the same polarization state.

However, this solution has its drawbacks, which are expressed in the fact that the presence of one polarization grating leads to a change in the direction of propagation of the initial radiation, which in turn leads to an uneven distribution of radiation spots.

Accordingly, a significant problem of many of the approaches discussed above is the presence of mechanical switching between operating modes in the near and far zones by distance, insufficient technological efficiency and reliability, the impossibility of working with unpolarized light while ensuring high brightness, which, due to the low energy efficiency of such systems, makes it difficult to register the reflected and scattered signal from the object, distance to which is being measured.

### SUMMARY

Provided are devices, methods, and systems which may use a combination of an active retarder and a liquid crystal (LC) lens to non-mechanically switch between the spot illumination mode and the flood illumination mode (e.g., between long-range and short-range operation, in a Time-of-Flight (ToF) camera illumination system).

Also provided are devices, methods, and systems which may polarize unpolarized light from a light source using a pair of spatially separated LC gratings to separate radiation with left-hand circular polarization (LCP) and right-hand circular polarization (RCP) in space to obtain high brightness in spot illumination mode and flood illumination mode.

Also provided is a technologically advanced, reliable and compact illumination system for a ToF camera module that has high speed, compactness, low weight, low power consumption, high reliability, is suitable for use in wearable devices, and allows for effective illumination of objects both at close and far distances without the need for mechanical switching between near and far illumination modes.

In accordance with an aspect of the disclosure, an optical illumination system for a time-of-flight (ToF) imaging device includes: at least one unpolarized light source module configured to emit light; at least two spatially-separated liquid crystal (LC) gratings configured to spatially separate the light into a plurality of spatially-separated light components having orthogonal circular polarizations, and to redirect the plurality of spatially-separated light components to at least one active retarder; the at least one active retarder placed after the at least two spatially separated LC gratings along an illumination path, wherein the at least one active retarder may be further configured to change a polarization state of the light to an opposite polarization state, and to switch between a spot illumination mode and a flood illumination mode, wherein according to the spot illumination mode, a point illumination pattern may include a plurality of point illumination spots is generated on a surface of an illuminated object, and according to the flood illumination mode, a continuous illuminated spot is generated on the surface of the illuminated object; at least one LC lens placed after the at least one active retarder along the illumination path, wherein the at least one LC lens may be further configured to generate an illumination field, wherein the plurality of spatially-separated light components include a first light component having a first circular polarization, and a second light component having a second circular polarization that is orthogonal to the first circular polarization, wherein the at least one LC lens has a positive optical power with respect the first light component according to the spot illumination mode, and wherein the at least one LC lens has a negative optical power with respect the second light component according to the flood illumination mode.

The optical illumination may further include at least one lens array placed after the at least one unpolarized light source module along the illumination path, wherein the at least one lens array is further configured to collimate the light emitted by the at least one unpolarized light source module.

The optical illumination system may further include at least one diffraction grating configured to multiply a number of a plurality of light beams emitted from the optical illumination system according to the spot illumination mode, and to increase an angular field of illumination provided by the plurality of light beams.

The plurality of spatially-separated light components may be redirected to the at least one active retarder such that the plurality of spatially-separated light components do not overlap at an aperture of the at least one active retarder.

The at least one active retarder may include a first half-aperture active retarder and a second half-aperture active retarder, the first half-aperture active retarder may be further configured to change a polarization state of the first light component, and the second half-aperture active retarder may be further configured to change a polarization state of the second light component independently of the first half-aperture active retarder.

The at least one LC lens may include a composite aperture LC lens, and different parts of an aperture of the at least one LC lens ay have optical powers having opposite signs for a single circular polarization.

An additional passive half-aperture retarder may be placed before the a least one active retarder along the illumination path, and the additional passive half-aperture retarder may be further configured to change the polarization state of the light on only half of an aperture of the at least one active retarder.

The at least one LC lens may include at least one from among an active LC lens, a lens may include a birefringent material, a metalens, a diffractive (DOE) or holographic (HOE) optical element, a gradient refractive index (GRIN) lens, a liquid lens, a metalens having a Pancharatnam-Berry phase.

A substrate of at least one optical element included in the optical illumination system may be transparent in a radiation range of the at least one unpolarized light source module, the substrate may include at least one from among glass, a polymeric material, and a crystal.

A period of at least one of the at least two spatially-separated LC gratings may be constant.

Periods of the at least two spatially-separated LC gratings may be same.

At least one of the at least two spatially-separated LC gratings may include at least one from among an active LC grating, an array of LC lenses, an array of active LC lenses, a metasurface, an array of gradient refractive index (GRIN) elements, an array of diffractive optical elements (DOE), an array of holographic optical elements (HOE), an acoustic grating, a prismatic structure, and a birefringent material.

A spectral range of the at least one unpolarized light source module may include at least one from among an infrared (IR) range, a visible range, and a multispectral range.

The at least one lens array may include at least one from among a spherical lens, an aspherical lens, a metalens, a diffractive optical element (DOE), a holographic optical element (HOE), a gradient refractive index (GRIN) lens, a liquid lens, and an LC lens.

A distance between elements included in the at least one lens array may be constant in at least one direction.

Optical powers of individual elements included in the at least one lens array may be constant.

Each individual element included in the at least one lens array may include an aperture having at least one of a square shape, a circular shape, a rhombic shape, an elliptical shape, a rectangular shape, and a hexagonal shape.

The at least one diffraction grating may include at least one from among an active LC grating, an array of LC lenses, an array of active LC lenses, an LC grating, a metasurface, an array of gradient refractive index (GRIN) elements, an acoustic grating, an array of diffractive optical elements (DOE), an array of holographic optical elements (HOE), a prismatic structure, a mirror structure, and a birefringent material.

A period of the at least one diffraction grating may be constant along an aperture of the at least one active retarder.

The optical illumination system may further include a material filling at least one space between optical elements, and the material may include at least one from among a substrate, a coating applied to the substrate, an additional coating applied at least one of before and after the optical elements along the illumination path, air, glass, a polymeric material, a crystal, and a material that is transparent in a radiation range of the at least one unpolarized light source module.

The optical illumination system may further include a combination including a retarder and a polarizer, and the combination may be further configured to increase a signal-to-noise ratio of the optical illumination system.

The switching may be performed periodically.

According to the spot illumination mode, the plurality of point illumination spots may include a point illumination spot having at least one from among a circular shape, a rectangular shape, an elliptical shape, a linear shape, and an arbitrary polygonal shape.

According to the spot illumination mode, sizes and shapes of the plurality of point illumination spots may be same across an entire image field.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an illumination system for determining distance to objects located at relatively long distances with a ray path from a single light source of the light source module, according to an embodiment.

FIG. 2 illustrates an illumination system for determining distance to objects located at close distances with the ray path from a single light source of the light source module, according to an embodiment.

FIG. 3 illustrates a process for using an active retarder together with an LC lens in an illumination system for determining distance to objects located at relatively long distances, according to an embodiment.

FIG. 4 illustrates a process for using an active retarder together with an LC lens in an illumination system for determining distance to objects located at close distances, according to an embodiment.

FIG. 5 illustrates a spatial separation between two LC gratings to achieve polarization of unpolarized light with high efficiency, according to an embodiment.

FIGS. 6A and 6B examples of the illumination system for determining distance to objects located at relatively long distances in the spot illumination mode and in the flood illumination mode at near distances, according to embodiments.

FIGS. 7A and 7B examples of a full-aperture active retarder used in combination with an additional passive half-aperture retarder, according to embodiments.

FIGS. 8A and 8B illustrate examples of a full-aperture active retarder in combination with a composite aperture LC lens, according to an embodiment.

FIG. 9 illustrates examples of distances between elements of a lens array, according to an embodiment.

FIG. 10 illustrates an example of setting an optical power of the lens array elements, according to an embodiment.

FIGS. 11A, 11B, 11C, 11D, 11E and 11F illustrate examples of a spatial distribution of intensity on the object surface when the illumination system operates in the spot illumination mode, in the flood illumination mode, and in their combinations, according to embodiments.

### DETAILED DESCRIPTION

Example embodiments of the present disclosure are described below. A person skilled in the art will understand that the following is not a complete theoretical description of all known technologies, but only that part of such a description that may be useful for the theoretical justification and practical implementation of example embodiments of the present disclosure.

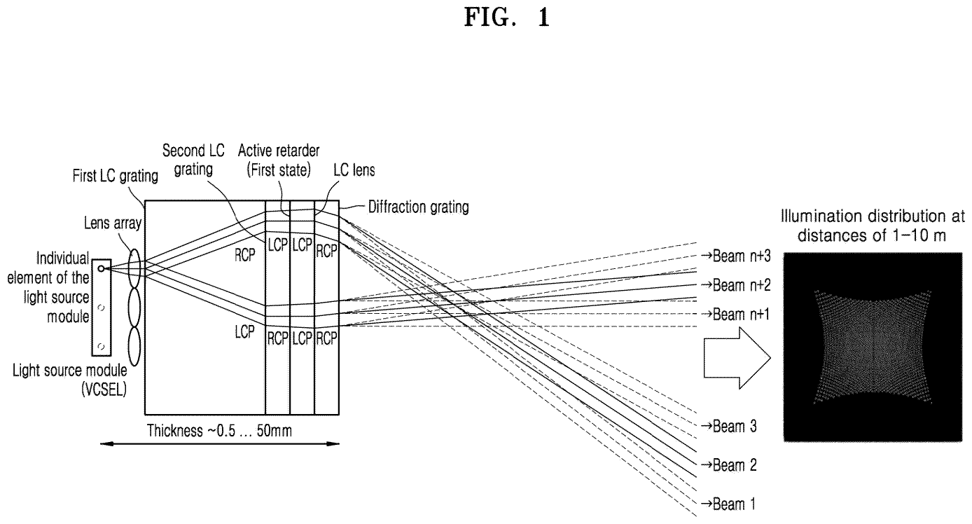

FIG. 1 illustrates an example of an illumination system operating to determine distances to objects located at relatively long distances (e.g., distances in a range of 1 meter (m) to 10 m from a light source) with a ray path (e.g., an illumination path) from a single light source of a light source module. According to embodiments, the light source may include, for example, a source of infrared (IR), unpolarized light having a wavelength in a range 800 nm to 1000 nm, and having some angular divergence, but embodiments are not limited thereto. As an example, a vertical cavity surface emitting laser (VCSEL), which may be or may include an array of unpolarized IR light sources, may be used as a light source module for the illumination system. The unpolarized light, which may include or may be referred to as radiation, propagating from the light source passes through an array of lenses, which are included in a lens array, which pre-collimates the radiation. Next, the radiation enters the first liquid crystal (LC) grating to separate the emitted unpolarized light into radiation with orthogonal states of circular polarization, namely, radiation having left-hand circular polarization (LCP) and radiation having right-hand circular polarization (RCP), both to increase the resolution in the spot illumination mode and to increase the radiation field. Further, the radiation having LCP and radiation having RCP, separated by a certain angle relative to each other, diverge from each other by a sufficient distance so that they do not overlap each other, for which a material is used that is transparent in the required radiation range and has a certain thickness sufficient so that, following this thickness, a spatial shift between the radiation with LCP and the radiation having RCP accumulates.

After this, the spatially separated radiation having LCP and radiation having RCP fall on the second LC grating, on which the direction of the radiation beams is changed so that they propagate in accordance with the aperture of the LC lens. Then the spatially separated radiation beams fall on the active retarder, which may, based on the voltage applied to it, either not change the polarization state, or may change the polarization state of the radiation to the opposite polarization state (e.g., from LCP to RCP, or from RCP to LCP). In this case, when the illumination system operates to determine distance to objects located at relatively long distances, the active retarder causes the polarization state of both previously separated parts (e.g., components) of the radiation to be a polarization state of LCP (which may be referred to as a first polarization state). The radiation then enters an LC lens having positive optical power with respect to radiation having LCP, to form a field of illumination and for final collimation of the pre-collimated radiation. Finally, the final collimated radiation enters a diffraction grating configured to increase the resolution in the spot illumination mode and to expand the field of illumination.

In some embodiments, the optical elements discussed above such as the first LC grating, the second LC grating, the active retarder, the LC lens and the diffraction grating may be implemented as coatings on the surfaces of a material that is transparent in the corresponding radiation range, forming a substrate of a certain thickness for each of the above-mentioned optical elements. In some embodiments, the total thickness of the above-mentioned substrates may be, for example, in a range from 0.5 mm to 50 mm, but embodiments are not limited thereto. In some embodiments, a greater part of the thickness may fall on the substrate of the first LC grating, which, as discussed above, may be used to accumulate a spatial shift along the above-mentioned thickness between radiation having LCP and radiation having RCP. According to embodiments, the coatings containing the above-mentioned optical elements may be applied to both surfaces of the above-mentioned substrates, but embodiments are not limited thereto. According to embodiments, the substrates may be arranged in the system in such a way that the optical elements in the form of coatings applied to the substrates are spatially separated from each other by a certain gap formed by a material that is transparent in the corresponding radiation range, which in some embodiments may be at least one of the material of the substrates and air. However, these are only examples, and embodiments are not limited thereto.

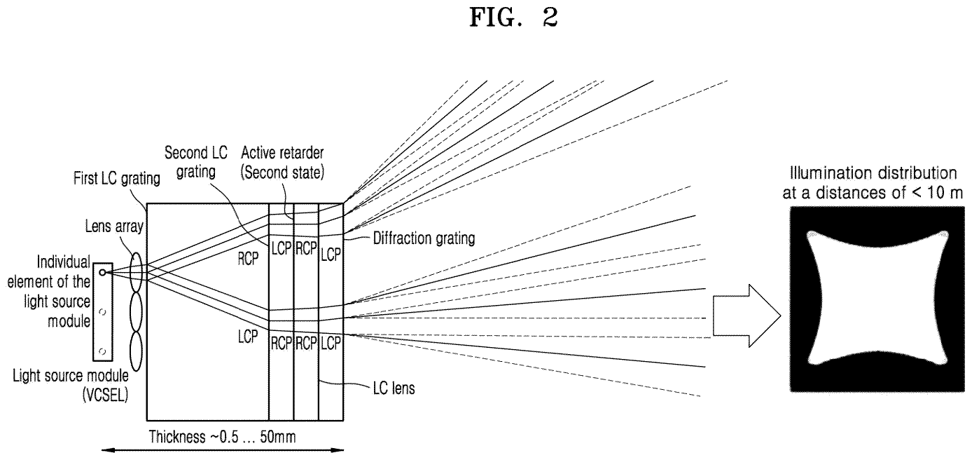

Then, the radiation that has passed through the diffraction grating is concentrated into a plurality of radiation beams (e.g., Beam 1 through Beam n+3), which, when hitting an object (which may for example be located in the range of distances from 1 m to 10 m from the light source), generate a plurality of point illumination spots on a surface of the object. An example of a pattern formed by the plurality of point illumination spots is shown in FIG. 1. As can be seen in FIG. 1, each of the plurality of point illumination spots forming this pattern has sufficient energy characteristics so that the radiation scattered or reflected from this illuminated point on the object surface may be recorded by a receiver for collecting the reflected or scattered optical signal, albeit with a reduced resolution, compared to the flood illumination mode shown in FIG. 2 and explained below, wherein the resolution is determined by the number of radiation beams forming the pattern shown in FIG. 1.

FIG. 2 illustrates an example of the illumination system operating to determine distance to objects located at relative close distances (e.g., in a range of less than 1 m from the light source module of the present system) with a ray path from a single light source of the light source module. Similar to FIG. 1, the example shown in FIG. 2 shows a ray path from a single light source of the light source module, which may be a source of unpolarized radiation having a wavelength in a range of, for example, 800 nm to 1000 nm (e.g., unpolarized IR light), and having some angular divergence, but embodiments are not limited thereto. For example, a VCSEL surface-emitting laser, which may be or may include an array of unpolarized IR light sources, may be used as a light source for the illumination system. The radiation propagating from the light source passes through an array of lenses, which are included in a lens array, which pre-collimates the radiation. Then the radiation enters the first LC grating to separate the emitted unpolarized light into radiation with LCP and radiation with RCP. Then the radiation with LCP and radiation with RCP, separated by a certain angle relative to each other, move away from each other by a sufficient distance so that they do not overlap each other, for which a material is used that is transparent in the corresponding radiation range and has a certain thickness sufficient for the spatial shift between the radiation with LCP and the radiation with RCP to accumulate.

After spatial separation of the radiation, the radiation having LCP and the radiation having RCP enter the second LC grating, where the direction of the radiation beams changes so that they propagate in accordance with the aperture of the LC lens. Then the spatially separated radiation beams enter the active retarder, which, depending on the voltage applied to it, can either not change the polarization state, or change the polarization state of the radiation to the opposite polarization state (e.g., from LCP to RCP, or from RCP to LCP). In this case, when the illumination system operates to determine distance to objects located at relatively close distances, the active retarder causes the polarization state of both previously separated parts (e.g., components) of the radiation to be a polarization state of RCP (which may be referred to as a second polarization state). The radiation then enters an LC lens with negative optical power for radiation having RCP, to form a field with continuous illumination.

Finally, the radiation enters a diffraction grating configured to increase the field of illumination. In this case, continuous illumination is formed in a given angular range.

According to embodiments, optical elements such as the first LC grating, the second LC grating, the active retarder, the LC lens and the diffraction grating discussed above may be substantially similar to those in the example described above with reference to FIG. 1.

Then, the radiation that has passed through the diffraction grating is concentrated into a single radiation beam, which, when it reaches an object which is in the range of distances of up to 1 m from the light source, generates a continuous illuminated spot on the surface of the object, with generating a pattern shown on the right in FIG. 2. As can be seen from FIG. 2, due to the small distance from the light source of the present system to the object, distance to which is to be determined, this continuous illuminated spot, forming the pattern shown on the right in FIG. 2, has sufficient energy characteristics so that the radiation scattered or reflected from the object surface may be recorded by a receiver for collecting the reflected or scattered optical signal, moreover, with increased resolution, in comparison with the spot illumination mode, in which the resolution is determined by the number of radiation beams forming the pattern shown in FIG. 1. For the above reasons, due to generating the mentioned continuous illuminated spot, the operating mode of the illumination system at close range may be referred to as a flood illumination mode, in contrast to the spot illumination mode used at relatively long range (as described above with reference to FIG. 1).

As discussed above, the radiation incident on the active retarder has two spatially separated components having different polarization states (e.g., radiation with LCP and radiation with RCP). The active retarder is designed in such a way that two different parts of its aperture may independently change the polarization state of the radiation incident on the active retarder to the opposite polarization state. For example, one portion of the aperture of the active retarder may change the polarization of the radiation from the RCP to the LCP, while another portion of the aperture of the active retarder may maintain the polarization state of LCP of the incident radiation without changing, so that all of the radiation has a polarization state of LCP (e.g., the first state). As another example, one part of the aperture of the active retarder may maintain keep the polarization state of RCP of the incident radiation without changing, while the other part of the aperture of the active retarder can change the polarization state of the radiation from LCP to RCP, so that all of the radiation has a polarization state of RCP (e.g., the second state). Due to this, the active retarder is used to switch back and forth between the flood illumination mode and the spot illumination mode.

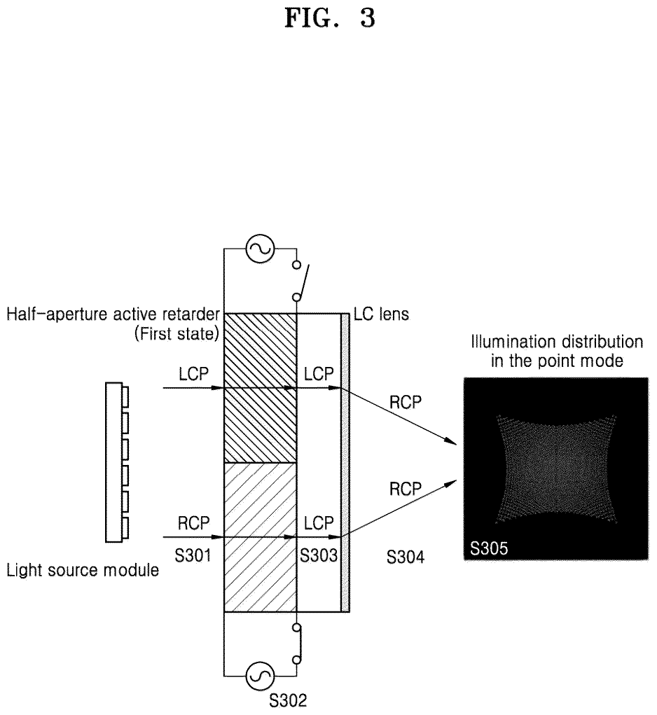

FIG. 3 illustrates a process for using a composite active retarder together with an LC lens in an illumination system for determining distance to objects located at relatively long distances, according to a spot illumination mode.

As shown in FIG. 3, at operation S301, the radiation incident on the active retarder has two spatially separated components having different polarization states (e.g., radiation with LCP and radiation with RCP).

At operation S302, the composite active retarder changes the polarization state of the radiation incident on it from RCP to LCP (e.g., as illustrated in the lower part of FIG. 3), while the radiation incident on it with LCP propagates through the active retarder unchanged (e.g., as illustrated in the upper part of FIG. 3). FIG. 3 shows an example in which the composite active retarder includes two half-aperture active retarders, each of which operates independently of the other and changes the polarization state of the radiation incident on it only on half of the aperture of the composite active retarder.

Thus, as shown at operation S303, after passing through the active retarder, the radiation over the entire aperture has LCP.

At operation S304, the radiation having LCP is focused by an LC lens, which has a positive optical power for the incident radiation having LCP.

At operation S305, the radiation focused by the LC lens, when it reaches the object is converted into a distribution of points on the object surface.

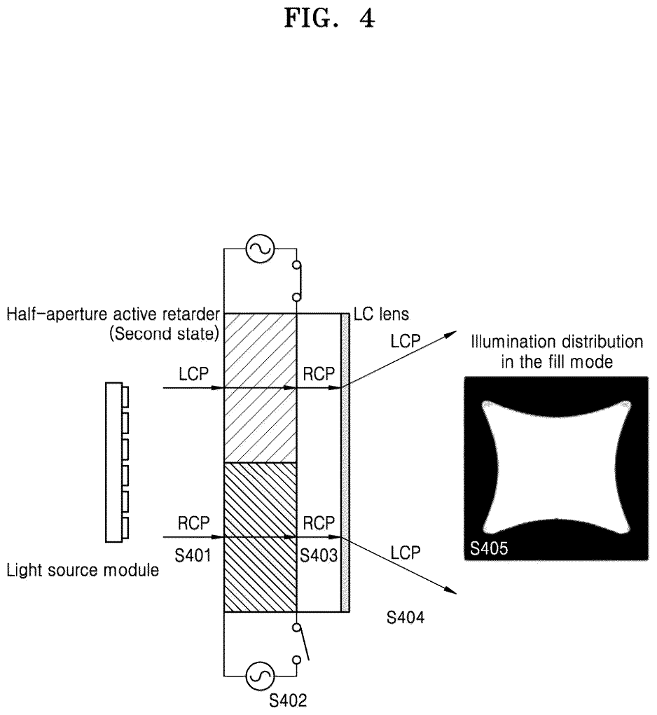

FIG. 4 illustrates a process for using a composite active retarder together with an LC lens in a illumination system for determining distance to objects located at close distances, according to the flood illumination mode.

As shown in FIG. 4, at operation S401, the radiation incident on the active retarder has two spatially separated components having different polarization states, namely radiation with LCP and radiation with RCP.

At operation S402, the composite active retarder changes the polarization state of the radiation incident on it from LCP to RCP (e.g., as illustrated in the upper part of FIG. 4), while the radiation incident on it with RCP propagates through the active retarder without changes (e.g., as illustrated in the lower part of FIG. 4). FIG. 4 shows an example in which the composite active retarder includes two half-aperture active retarders, each of which operates independently of the other and changes the polarization state of the radiation incident on it only on half of the aperture of the composite active retarder.

Thus, as shown at operation S403, after passing through the active retarder, the radiation has RCP over the entire aperture.

At operation S404, the radiation having RCP is focused by an LC lens, which has a negative optical power for the radiation having RCP.

At operation S405, the radiation focused by the LC lens, when it reaches the object, generates a continuous illuminated spot on the object surface.

Thus, as shown in FIG. 3 and FIG. 4, by using an active retarder together with an LC lens in the illumination system, non-mechanical switching between the spot illumination mode and the flood illumination mode is provided in the illumination system of a time-of-flight (ToF) imaging camera with a single light source module for determining distance to an object at both near and far distances.

Accordingly, embodiments may provide relatively fast switching (e.g., on an order of milliseconds) between a flood illumination mode and a spot illumination mode to determine distance to an object at both near and far distances. In addition, embodiments may provide increased service life of the illumination system by eliminating or reducing the use of mechanical components. Further, embodiments may reduce a size of the illumination system through the use of flat optical elements, allowing the illumination system to be more compact.

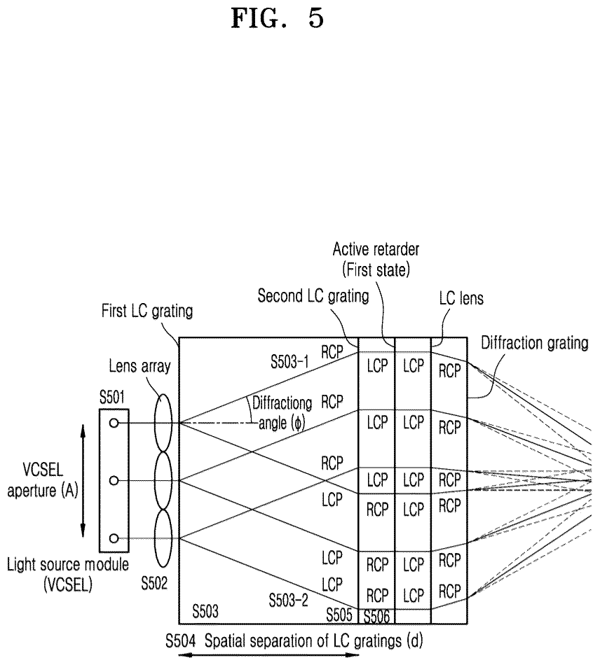

FIG. 5 illustrates an example of spatial separation of two LC gratings for implementing polarization of unpolarized light with high efficiency, wherein the direction of radiation propagation after passing two LC gratings should be matched with the aperture of the active retarder and LC lens. According to embodiments, the active retarder with the LC lens may be used for non-mechanical switching between the spot illumination mode and the flood illumination mode. The active retarder and the LC lens may be, or may include, polarization-sensitive optical elements, and may be capable of performing functions assigned to them according to polarized input radiation.

As shown in FIG. 5, at operation S501, radiation is emitted from an unpolarized IR light source, such as a VCSEL, for example.

At operation S502, the radiation, pre-collimated by the lens array, is propagated to the first LC grating.

At operation S503, the first LC grating divides the unpolarized light into two parts, wherein at operation S503-1, the radiation with RCP propagates in the direction of the +1^{st} diffraction order, deviating from the direction of the main optical axis by the diffraction angle φ, and operation S503-2, the radiation with LCP propagates in the direction of the −1^{st} diffraction order, deviating from the direction of the main optical axis by the diffraction angle φ in the other direction. Separation of radiation on the first LC grating leads to a two-fold multiplication of the radiation beams, and therefore to an increase in the angular field of illumination.

At operation S504, the spatial separation of the RCP and LCP radiation fluxes is achieved by providing a double diffraction angle between them after the first LC grating and by spatially separating the LC gratings, calculated according to Equation 1:

$$d > \frac{A}{2 \cdot tg φ} , \qquad ( 1 )$$

In Equation 1, d may denote a spatial separation of the LC gratings (e.g., a distance between the first and second LC gratings), A may denote a size of an aperture of the radiation beam incident on the first LC grating, φ may denote the absolute value of the diffraction angle by which the radiation is deflected after the first LC grating.

According to embodiments, the parameter d may denote the value of the spacing of the first and second LC gratings at such a distance that the radiation components with RCP and LCP after separation on the first LC grating do not overlap each other.

In this case, the diffraction angle φ depends on the wavelength of the radiation emitted by the light source, the refractive index of the radiation propagation medium, and the period of the first LC grating.

At operation S505, the spatially separated radiation with RCP and radiation with LCP is incident on a second LC grating, which redirects the radiation and changes the polarization state in opposite directions (e.g., from RCP to LCP and/or from LCP to RCP).

At operation S506, after the second LC grating, the polarized light has different components spatially separated by the polarization state and propagates in a direction matched with the LC lens.

In this way, a pair of spatially separated LC gratings is used to separate left-hand circularly polarized (LCP) radiation from right-hand circularly polarized (RCP) radiation in order to obtain high-brightness illumination in both spot illumination mode and flood illumination mode.

Therefore, according to embodiments, determination of distance to an object may be carried out in a wide range of distances due to the spatial separation of the first and second LC gratings, which leads to polarization of unpolarized light with high efficiency.

According to embodiments, the illumination system may be compact and suitable for wearable devices thanks to flat optical elements.

According to embodiments, an increase in resolution and angular field of illumination is achieved by separating radiation with different polarizations on the first LC grating;

According to embodiments, a reduction in energy consumption may be achieved by spatially separating the LC gratings, which leads to polarization of unpolarized light with high efficiency.

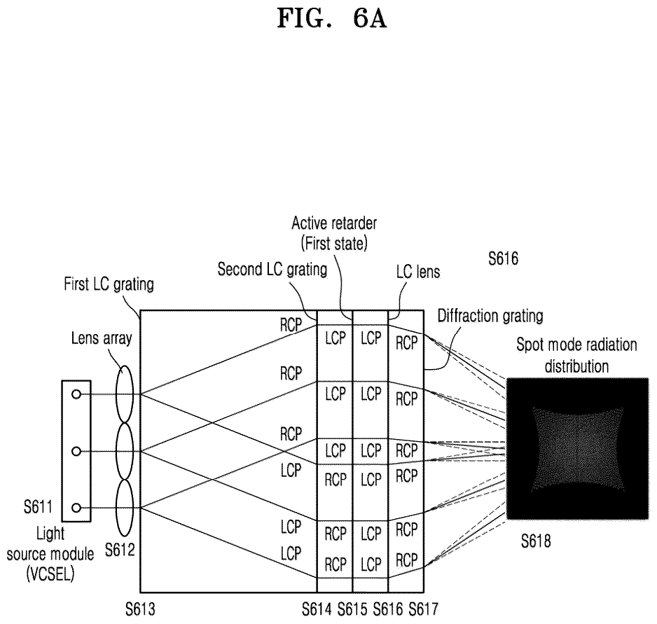

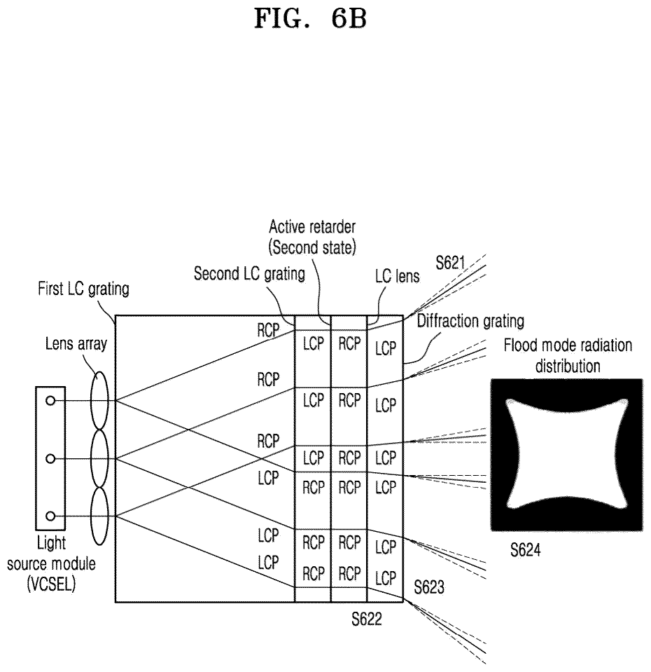

FIGS. 6A and 6B illustrate processes for using the illumination system determine distances to objects located at relatively long distances in the spot illumination mode (e.g., as illustrated in FIG. 6A) and in the flood illumination mode at relatively close distances (e.g., as illustrated in FIG. 6B).

As shown in FIG. 6A, an illumination system including a unpolarized IR light source, such as a VCSEL, may emit unpolarized radiation (e.g., unpolarized light) at operation S611. A lens array located after the light source along an illumination path may be used to pre-collimate the radiation from the light source at operation at operation S612. At operation S613, the unpolarized light from the light source enters the first LC grating through a lens array. The first LC grating splits the unpolarized radiation into two parts: radiation with RCP propagates in the direction of the +1^{st} diffraction order, and radiation with LCP propagates in the direction of the −1^{st} diffraction order. Splitting the radiation on the first LC grating results in multiplication of the radiation beams, which means a two-fold increase in resolution and an increase in the angular field of illumination.

At operation S614, spatially-separated radiation having a polarization state of RCP and radiation having a polarization state of LCP enters a second LC grating, which redirects the radiation and changes the polarization state in opposite directions (e.g., from RCP to LCP and/or from LCP to RCP).

After the second LC grating, the polarized light has two different components, spatially separated by the state of polarization. At operation S615, the radiation enters the active retarder, which is used to switch the illumination modes of objects. For example, in the spot illumination mode, corresponding to the previously mentioned first state of the active retarder, the following occurs.

At operation S615, a portion of the active retarder aperture changes the polarization state of the incident radiation from RCP to LCP, the another portion of the active retarder does not change the polarization state of LCP. After the active retarder, all radiation has a polarization state of LCP.

At operation S616, the radiation having LCP is focused by an LC lens that has a positive optical power for the incident radiation having the polarization state of LCP.

At operation S617, the diffraction grating placed after the LC lens is capable of increasing the resolution in the spot illumination mode and the angular field of illumination due to diffraction on the diffraction grating structure.

At operation S618, the radiation diffracted by the diffraction grating, when hitting an object, distance to which is to be determined, will be converted into a distribution of points on the object surface.

In the flood illumination mode shown in FIG. 6B, corresponding to the second state of the active retarder described above, the following occurs.

At operation S621, a portion of the active retarder aperture changes the polarization state of the incident radiation from LCP to RCP, and another portion of the active retarder does not change the polarization state of RCP. After the active retarder, all radiation has a polarization state of RCP.

At operation S622, radiation having RCP is focused by an LC lens, which has a negative optical power for incident radiation having the polarization state of RCP.

At operation S623, the diffraction grating placed after the LC lens is able to increase the angular field of illumination due to diffraction on the grating structure.

At operation S624, the radiation diffracted by the diffraction grating, when it reaches the object, generates a continuous illuminated spot on the object surface.

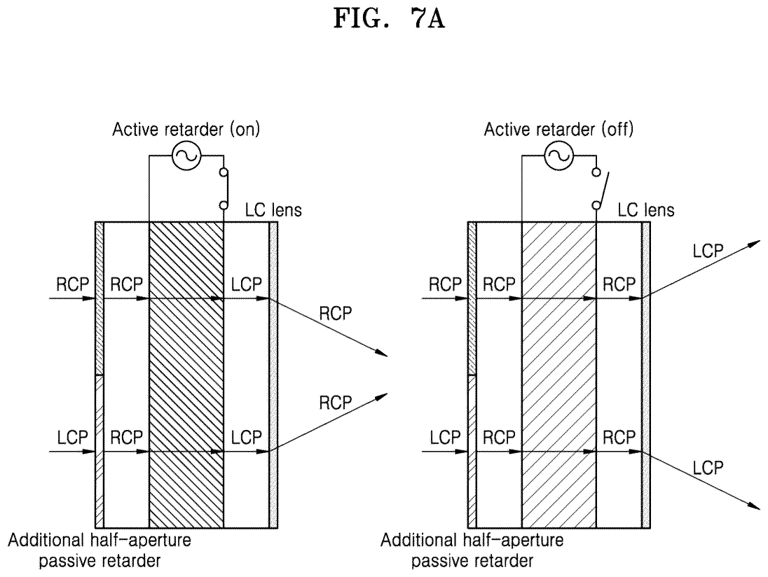

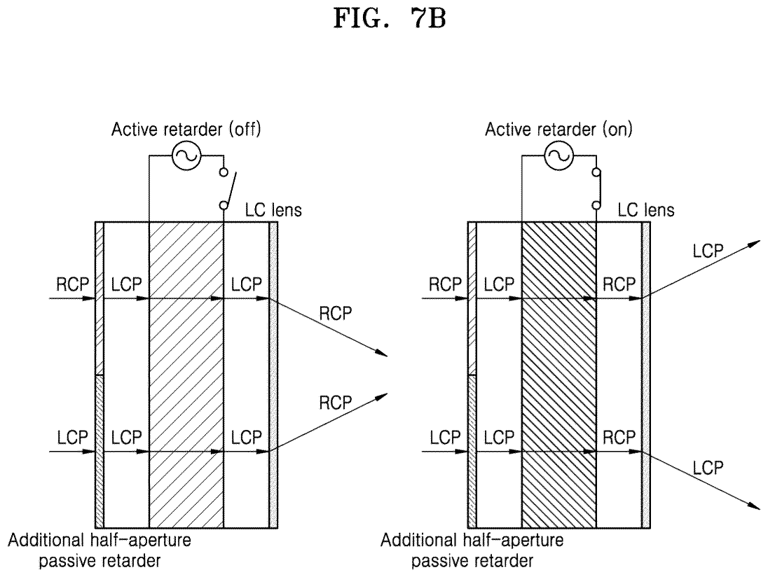

FIGS. 7A and 7B illustrate examples of processes for using a full-aperture active retarder in combination with an additional passive half-aperture retarder. Due to this, the active retarder is not made as a composite including two half-aperture plates, and instead includes a single one, and an additional passive half-aperture retarder is placed in front of the active retarder along the illumination path.

In particular, FIGS. 7A and 7B illustrate examples in which an additional passive half-aperture retarder is used, which is placed in front of the full-aperture active retarder, which is turned on or off, both in the spot illumination mode (left portions of FIGS. 7A and 7B) and in the flood illumination mode (right portions of FIGS. 7A and 7B), and which changes the radiation having LCP to radiation having RCP on half the aperture (e.g., as illustrated in FIG. 7A), or changes the radiation having RCP to the radiation having LCP on half the aperture (e.g., as illustrated in FIG. 7B).

The additional passive retarder may be made, as a non-limiting example, in the form of a half-wave plate, and no electrical voltage needs to be applied to it to perform its functions, which is why it is called passive, which can increase the technological efficiency of production and the operational reliability of the entire illumination system due to the use of a simpler single-piece full-aperture active retarder.

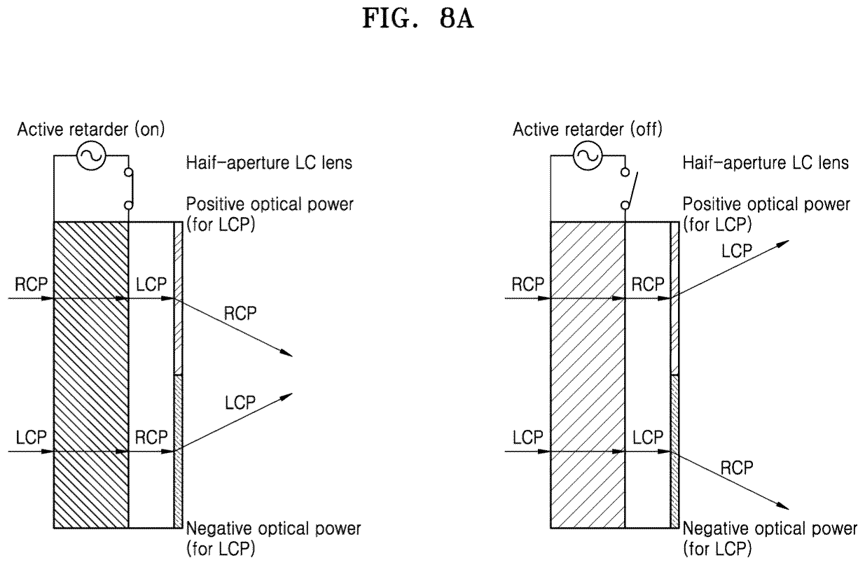

FIGS. 8A and 8B illustrate examples of a full-aperture active retarder which is used in combination with a composite aperture LC lens. In this case, as in the examples described above, the active retarder is not made composite (e.g. two half-aperture plates) and is instead made single. However, a composite aperture LC lens is placed after the active retarder along the illumination path. FIGS. 8A and 8B show examples in which the composite LC lens includes of two half-aperture LC lenses, with a positive optical power in one half the aperture and with a negative optical power in the second half the aperture for LCP. The composite aperture LC lens has a positive optical power to form a point image (left portions of FIGS. 8A and 8B) and a negative optical power to form a fill image (right portions of FIG. 8B).

In particular, FIGS. 8A and 8B illustrate examples that employ a composite aperture LC lens with positive optical power in one half the aperture and negative optical power in the other half the aperture for LCP, which is placed after a full-aperture active retarder in both the spot illumination mode (left portions of FIGS. 8A and 8B) and the flood illumination mode (right portions of FIGS. 8A and 8B).

The composite aperture LC lens may be made, as a non-limiting example, in the form of two half-aperture LC lenses with opposite signs of optical power (e.g., positive optical power and negative optical power), which may improve the manufacturability of production and the operational reliability of the entire illumination system due to the use of a relatively simple single-piece full-aperture active retarder.

In an example, according to a spot illumination mode, the radiation after passing through the active retarder may have a polarization state of RCP and be focused by an LC lens having a positive optical power for RCP, and according to a flood illumination mode, the radiation after passing through the active retarder may have a polarization state of LCP and be focused by an LC lens having a negative optical power for LCP.

According to an embodiment, the LC lens may include at least one of polarization-sensitive elements with optical power for example at least one of: an active LC lens, a lens made of a birefringent material, a metalens, a diffractive optical element (DOE), a holographic optical element (HOE), a gradient refractive index (GRIN) lens, a metalens with Pancharatnam-Berry phase, a liquid lens, or a combination of the above.

According to embodiments, any materials that are transparent in the radiation range of the light source may be used as substrates for optical elements of the illumination system, for example at least one of: glass, polymeric materials, crystals, etc.

According to embodiments, the periods of the first and second LC gratings may be constant or variable along the aperture, which may be used to correct optical aberrations introduced by the illumination system, for example, to correct distortion, as well as to change distance between points on the object surface in the spot illumination mode, for example, in order to improve the resolution in a certain area of the object image. In addition, the periods of the first and second LC gratings may be the same or different, which may be used to change distance between points on the object surface in the spot illumination mode, for example, in order to improve the resolution in the center of the object image.

According to embodiments, each of the first LC grating and the second LC gratings may be implemented in the form of, or may include, at least one of: an active LC grating, an array of LC lenses, an array of active LC lenses, an LC grating based on a metasurface, an array of GRIN elements, based on an array of DOE, an array of HOE, an acoustic grating, a prismatic structure, a structure made of birefringent material, or a combination of the above.

According to embodiments, the lens array may be placed in front of the first LC grating, or the lens array may be placed after the first LC grating, or the active retarder may be placed after the first LC grating, or the active retarder may be placed after the second LC grating, or the diffraction grating may be placed after the first LC grating, or the diffraction grating may be placed after the second LC grating, or the diffraction grating may be placed after the active retarder, or the diffraction grating may be placed after the LC lens.

According to embodiments, the passive retarder may be placed in front of the active retarder, or the passive retarder may be placed after the active retarder, or the LC lens may be placed in front of the active retarder, or the LC lens may be placed after the active retarder, or the passive retarder may be placed in front of the LC lens, or the passive retarder may be placed after the LC lens.

According to embodiments, the spectral range of the light source module may be in an IR range, in visible range, or in a multispectral range.

According to embodiments, the polarization state of the radiation of the light source module may be either unpolarized, or linearly polarized, or have circular polarization, however, in this case, an additional retarder may be placed in front of the first LC grating.

According to embodiments, an element of the at least one lens array may be implemented in the form of, or may include, at least of: a spherical lens, an aspherical lens, a metalens, a DOE, a HOE, a GRIN lens, a liquid lens, or an LC lens, or a combination of the above.

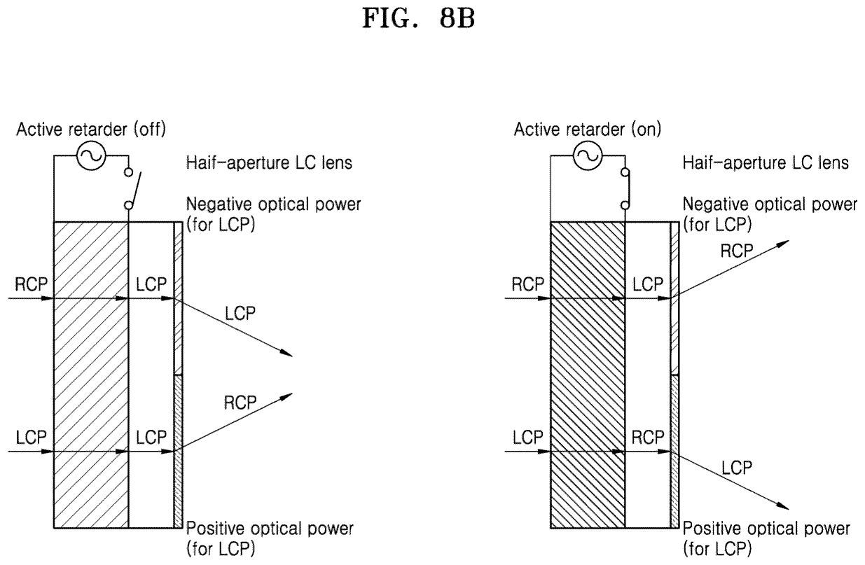

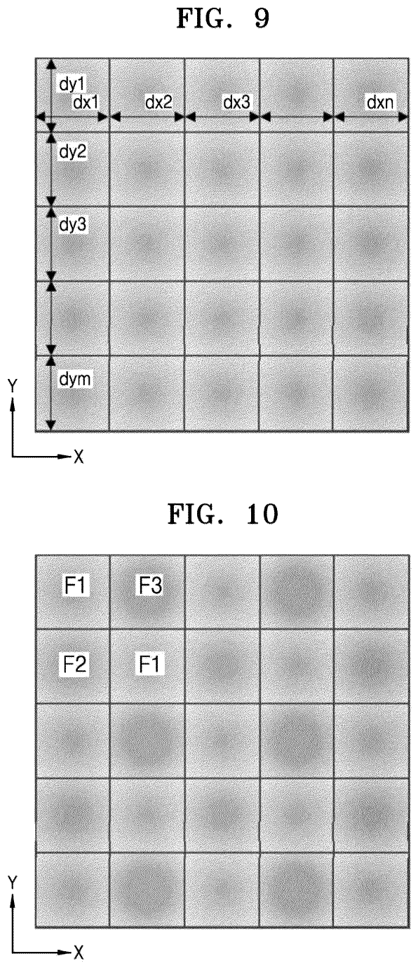

FIG. 9 illustrates examples of distances between the elements of the at least one lens array, determining the period of the lens array,

In this case, distance between elements of the lens array may be set constant, according to Equation 2:

$$dx 1 = dx 2 = d x 3 = … = dxn , dy 1 = dy 2 = dy 3 = … = dym , \qquad ( Equation 2 )$$

In Equation 2, dx1, dx2, dx3, . . . dxn may denote dimensions of the lens array elements along the X axis, dy1, dy2, dy3, . . . dym may denote dimensions of the lens array elements along the Y-axis.

In some embodiments, distance between elements of the at least one lens array may be set to vary along the X-axis but be constant along the Y-axis, according to Equation 3:

$$dx 1 \neq dx 2 \neq d x 3 \neq … \neq dxn , dy 1 = dy 2 = dy 3 = … = dym , \qquad ( Equation 3 )$$

In some embodiments, distance between elements of the at least one lens array may be set constant along the X-axis but varying along the Y-axis, according to Equation 4:

$$dx 1 = d x 2 = d x 3 = … = dxn , dy 1 \neq dy 2 \neq dy 3 \neq … \neq dym , \qquad ( Equation 4 )$$

where dx1, dx2, dx3, dxn—dimensions of the lens array elements along the X axis;

In some embodiments, distance between elements of the at least one lens array may be set to vary along both the X and Y axes, according to Equation 5:

$$dx 1 \neq d x 2 \neq d x 3 \neq … \neq dxn , dy 1 \neq dy 2 \neq dy 3 \neq … \neq dym , \qquad ( Equation 5 )$$

FIG. 10 illustrates the principles of setting the optical power of the elements of the at least one lens array. According to embodiments, the optical power of the elements of the lens array may be both the same and different. In the latter case, the optical power F of the elements of the lens array may correspond to Equation 6:

$$F 1 \neq F 2 \neq F 3 \qquad ( Equation 6 )$$

In Equation 6, F1, F2, F3 may denote the optical powers of the lens array elements.

According to embodiments, each individual element of the at least one lens array, when viewed from above, may have an aperture in the shape of a square, circle, rhombus, ellipse, or have the shape of any other closed broken line, for example, rectangular, hexagonal, etc.

By varying the size and shape of individual elements of lens array, it is possible to introduce pre-distortions into the radiation pattern to compensate for aberrations introduced by the illumination system, for example, to compensate for distortion.

According to an embodiment, at least one diffraction grating may additionally be introduced, which has the effect of multiplying the point radiation beams in the spot illumination mode and increasing the angular field of illumination in at least one direction, for example, along the X or Y axis, or diagonally.

According to an embodiment, at least one diffraction grating may be implemented in the form of an active LC grating, based on an array of LC lenses, based on an array of active LC lenses, in the form of an LC grating, based on a metasurface, based on an array of GRIN elements, in the form of an acoustic grating, based on an array of diffractive (DOE) or holographic (HOE) optical elements, a prismatic structure, a mirror structure, a structure made of birefringent material, or in the form of a combination of the above.

According to an embodiment, the periods of the at least one diffraction grating may be constant or variable along the aperture.

According to an embodiment, the material that fills the spaces between optical elements implemented in the form of coatings applied to substrates, as well as the material of the substrates themselves, as well as the material of additional coating elements applied before and after the layers of coatings containing optical elements, is selected from a group of materials containing: air, glass, polymeric materials, crystals, or any other material that is transparent in the radiation range of the light source.

According to embodiments, the polarization-sensitive optical elements used in embodiments may have a useful signal efficiency of <100%. As a result, radiation that is not included in the useful signal may propagate in the system as crosstalk or noise. This leads to a decrease in the signal-to-noise ratio (SNR) of the illumination system.

According to embodiments, in order to increase the signal-to-noise ratio (SNR) of the illumination system, a combination of a retarder with a polarizer may be additionally introduced into the system, which may make it possible to increase the signal-to-noise ratio due to the absorption of noise radiation by these introduced optical elements.

According to embodiments, switching between the flood illumination mode and the spot illumination mode may be performed either periodically or non-periodically, either manually or automatically. The order of switching between the illumination modes is most often set automatically, for example, in augmented reality (AR), extended reality (XR), virtual reality (VR), mixed reality (MR) glasses, switching can be performed according to information from the eye tracking system, which tracks whether the user has focused his vision on an object in the near zone, or on an object in the far zone, according to which the illumination system switches to the flood illumination mode, responsible for the near zone, or the illumination system switches to the spot illumination mode, responsible for the far zone. Setting the optimal switching between the illumination modes allows to reduce the energy consumption of the illumination system, which is especially important for portable wearable devices.

According to an embodiment, the shape of an individual illuminated point spot on the object surface when the illumination system is operating in the spot illumination mode may be at least one of, for example, a circle, a rectangle, an ellipse, a line, a polygon of arbitrary shape.

According to an embodiment, a size and a shape of a single illuminated point spot on the object surface when the illumination system is operating in a spot illumination mode may be the same across the entire image field, or may differ.

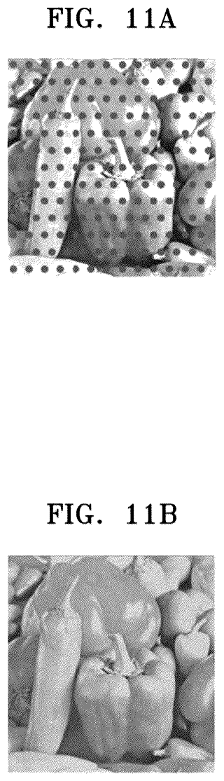

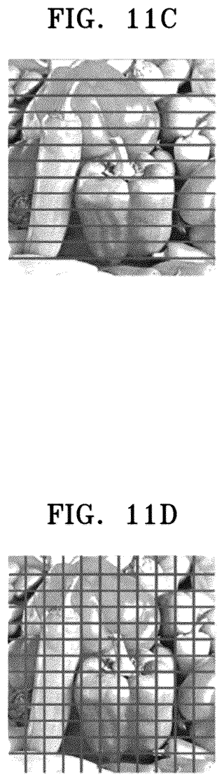

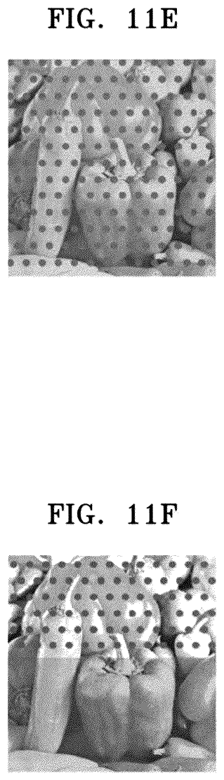

As shown in FIGS. 11A-11F, due to the spatial redistribution of the illuminated point spots on the object surface when the illumination system operates in the spot illumination mode, a situation is possible when not only the pattern of point spots shown in FIG. 11A, but also the line pattern shown in FIG. 11C, the lattice pattern shown in FIG. 11D are formed from the sets of the illuminated point spots on the object surface. In addition, numerous mixed illumination modes are possible, for example, a mode of superimposing a continuous illuminated spot obtained in the flood illumination mode on a dot pattern obtained in the spot illumination mode, as shown in FIG. 11E, or a mode of splitting by aperture in an arbitrary proportion between a continuous illuminated spot and a dot pattern, as shown in FIG. 11F. An arbitrary combination of the above is also possible. As an example, FIG. 11B also shows the image in flood illumination mode.

According to embodiments, the switchable illumination system for determining distance to an object may provide low cost, high speed, compactness and light weight, low energy consumption, and high reliability.

Thus, embodiments may provide an effective illumination system for a device for determining distance to an object, operating on the principle of time-of-flight (ToF) imaging and may be used in any device suitable for this, including computer vision systems or robotic vision systems; extended (XR) and/or augmented (AR) and/or virtual (VR) and/or mixed (MR) reality devices; smartphones, mobile computing devices, laptops, tablets; industrial automation systems; vehicles, both manned and unmanned, moving robotic devices; smart home systems; security systems; gaming systems, etc.

What is claimed is:

1. An optical illumination system for a time-of-flight (ToF) imaging device comprising:
at least one unpolarized light source module configured to emit light;
at least two spatially-separated liquid crystal (LC) gratings configured to spatially separate the light into a plurality of spatially-separated light components having orthogonal circular polarizations, and to redirect the plurality of spatially-separated light components to at least one active retarder;
the at least one active retarder placed after the at least two spatially separated LC gratings along an illumination path, wherein the at least one active retarder is configured to change a polarization state of the light to an opposite polarization state, and to switch between a spot illumination mode and a flood illumination mode, wherein according to the spot illumination mode, a point illumination pattern comprising a plurality of point illumination spots is generated on a surface of an illuminated object, and according to the flood illumination mode, a continuous illuminated spot is generated on the surface of the illuminated object;
at least one LC lens placed after the at least one active retarder along the illumination path, wherein the at least one LC lens is configured to generate an illumination field,
wherein the plurality of spatially-separated light components comprise a first light component having a first circular polarization, and a second light component having a second circular polarization that is orthogonal to the first circular polarization,
wherein the at least one LC lens has a positive optical power with respect the first light component according to the spot illumination mode, and
wherein the at least one LC lens has a negative optical power with respect the second light component according to the flood illumination mode.

2. The optical illumination system according to claim 1, further comprising at least one lens array placed after the at least one unpolarized light source module along the illumination path,
wherein the at least one lens array is further configured to collimate the light emitted by the at least one unpolarized light source module.

3. The optical illumination system according to claim 1, further comprising at least one diffraction grating configured to multiply a number of a plurality of light beams emitted from the optical illumination system according to the spot illumination mode, and to increase an angular field of illumination provided by the plurality of light beams.

4. The optical illumination system according to claim 1, wherein the plurality of spatially-separated light components are redirected to the at least one active retarder such that the plurality of spatially-separated light components do not overlap at an aperture of the at least one active retarder.

5. The optical illumination system of claim 4, wherein the at least one active retarder comprises a first half-aperture active retarder and a second half-aperture active retarder,
wherein the first half-aperture active retarder is configured to change a polarization state of the first light component, and
wherein the second half-aperture active retarder is configured to change a polarization state of the second light component independently of the first half-aperture active retarder.

6. The optical illumination system of claim 1, wherein the at least one LC lens comprises a composite aperture LC lens, and
wherein different parts of an aperture of the at least one LC lens have optical powers having opposite signs for a single circular polarization.

7. The optical illumination system according to claim 1, wherein an additional passive half-aperture retarder is placed before the a least one active retarder along the illumination path, and
wherein the additional passive half-aperture retarder is configured to change the polarization state of the light on only half of an aperture of the at least one active retarder.

8. The optical illumination system according to claim 1, wherein the at least one LC lens comprises at least one from among an active LC lens, a lens comprising a birefringent material, a metalens, a diffractive (DOE) or holographic (HOE) optical element, a gradient refractive index (GRIN) lens, a liquid lens, and a metalens having a Pancharatnam-Berry phase.

9. The optical illumination system according to claim 1, wherein a substrate of at least one optical element included in the optical illumination system is transparent in a radiation range of the at least one unpolarized light source module, and
wherein the substrate comprises at least one from among glass, a polymeric material, and a crystal.

10. The optical illumination system according to claim 1, wherein a period of at least one of the at least two spatially-separated LC gratings is constant.

11. The optical illumination system according to claim 1, wherein at least one of the at least two spatially-separated LC gratings comprises at least one from among an active LC grating, an array of LC lenses, an array of active LC lenses, a metasurface, an array of gradient refractive index (GRIN) elements, an array of diffractive optical elements (DOE), an array of holographic optical elements (HOE), an acoustic grating, a prismatic structure, and a birefringent material.

12. The optical illumination system according to claim 1, wherein a spectral range of the at least one unpolarized light source module comprises at least one from among an infrared (IR) range, a visible range, and a multispectral range.

13. The optical illumination system according to claim 2, wherein the at least one lens array comprises at least one from among a spherical lens, an aspherical lens, a metalens, a diffractive optical element (DOE), a holographic optical element (HOE), a gradient refractive index (GRIN) lens, a liquid lens, and an LC lens.

14. The optical illumination system according to claim 2, wherein a distance between elements included in the at least one lens array is constant in at least one direction.

15. The optical illumination system according to claim 2, wherein each individual element included in the at least one lens array comprises an aperture having at least one of a square shape, a circular shape, a rhombic shape, an elliptical shape, a rectangular shape, and a hexagonal shape.

16. The optical illumination system according to claim 3, wherein a period of the at least one diffraction grating is constant along an aperture of the at least one active retarder.

17. The optical illumination system according to claim 1, further comprising a material filling at least one space between optical elements,
wherein the material comprises at least one from among a substrate, a coating applied to the substrate, an additional coating applied at least one of before and after the optical elements along the illumination path, air, glass, a polymeric material, a crystal, and a material that is transparent in a radiation range of the at least one unpolarized light source module.

18. The optical illumination system according to claim 1, further comprising a combination including a retarder and a polarizer,
wherein the combination is configured to increase a signal-to-noise ratio of the optical illumination system.

19. The optical illumination system according to claim 1, wherein according to the spot illumination mode, the plurality of point illumination spots comprises a point illumination spot having at least one from among a circular shape, a rectangular shape, an elliptical shape, a linear shape, and an arbitrary polygonal shape.

20. The optical illumination system according to claim 1, wherein according to the spot illumination mode, sizes and shapes of the plurality of point illumination spots are same across an entire image field.
